(19) United States
(12) Patent Application Publication
(10) Pub. No.: US 2013/0238673 A1
(43) Pub. Date: Sep. 12, 2013

(54) INFORMATION PROCESSING APPARATUS, IMAGE FILE CREATION METHOD, AND STORAGE MEDIUM

(71) Applicant: Tsutomu Rokuhara, Tama-shi (JP)

(72) Inventor: Tsutomu Rokuhara, Tama-shi (JP)

(21) Appl. No.: 13/713,764

(22) Filed: Dec. 13, 2012

(30) Foreign Application Priority Data
Mar. 9, 2012 (JP) 2012-052918

(51) Int. Cl. G06F 17/30

(52) U.S. Cl. CPC G06F 17/3007
USPC 707/821

(57) ABSTRACT

According to one embodiment, an information processing apparatus is applied to a client management system which manages desktop environments of client terminals. The apparatus includes a first module and a second module. The first module creates a first image file for each group classified by model-independent elements of the client terminals. The first image file is a disk image file for the desktop environments. The first image file does not contain model-dependent elements of the client terminals. The second module creates a difference file for building a second image file containing the model-dependent elements of the client terminals based on the first image file.

### CROSS-REFERENCE TO RELATED APPLICATIONS

This application is based upon and claims the benefit of priority from Japanese Patent Application No. 2012-052918, filed Mar. 9, 2012, the entire contents of which are incorporated herein by reference.

### FIELD

Embodiments described herein relate generally to an information processing apparatus, image file creation method, and storage medium for managing the desktop environments of a plurality of client terminals.

### BACKGROUND

In recent years, various companies are examining the introduction of a system (client management system) for managing many client terminals in the office by a server.

In the client management system, a server in the client management system can centralize the management of the desktop environments (operating systems [OSs] and application programs) of many client terminals. The desktop environment is managed as a virtual image file which is a disk image file having the virtual hard disk (VHD) format and contains an OS and application programs.

When many management targets exist, they are generally grouped and managed for each group. Even when the server centralizes the management of the desktop environments of many client terminals, the desktop environments serving as management targets are grouped. The desktop environments are generally grouped in the order of models (broad category)→application programs (narrow category).

However, when model-dependent elements such as a device driver and model-independent elements such as an application program are compared in terms of the update and module addition frequencies, the frequencies are much higher for the latter elements.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing the configuration of a client management system to which an information processing apparatus (virtual image creation and distribution server) according to an embodiment is applied.

FIG. 2 is an exemplary view for explaining an example of communication procedures between the client management system in FIG. 1 and a rich client terminal (virtualization client terminal).

FIG. 3 is an exemplary view for explaining an example of communication procedures between the client management system in FIG. 1 and a thin client terminal.

FIG. 4 is an exemplary view for explaining a roaming function provided by a connection broker applied to the client management system in FIG. 1.

FIG. 5 is an exemplary view for explaining user profiles managed by the connection broker applied to the client management system in FIG. 1.

FIG. 6 is an exemplary block diagram for explaining cooperation to create a virtual image file in the client management system in FIG. 1.

FIG. 7 is an exemplary view for explaining conventional processes of building a virtual image file.

FIG. 8 is an exemplary view for explaining processes of building a virtual image file in the client management system in FIG. 1.

FIG. 9 is an exemplary view showing table A stored in a database by a management server applied to the client management system in FIG. 1.

FIG. 10 is an exemplary view showing table B stored in the database by the management server applied to the client management system in FIG. 1.

FIG. 11 is an exemplary view showing table C stored in the database by the management server applied to the client management system in FIG. 1.

FIG. 12 is an exemplary view showing table D stored in the database by the management server applied to the client management system in FIG. 1.

FIG. 13 is an exemplary flowchart showing the sequence of virtual image file creation processing to be executed in the client management system in FIG. 1.

### DETAILED DESCRIPTION

Various embodiments will be described hereinafter with reference to the accompanying drawings.

In general, according to one embodiment, an information processing apparatus is applied to a client management system which manages desktop environments of a plurality of client terminals. The apparatus includes a first image file creation module and a second image file creation module. The first image file creation module is configured to create a first image file for each group classified by model-independent elements of the plurality of client terminals. The first image file is a disk image file for the desktop environments. The first image file does not contain model-dependent elements of the plurality of client terminals. The second image file creation module is configured to create a difference file for building a second image file containing the model-dependent elements of the plurality of client terminals based on the first image file.

When many management targets exist, they are generally grouped and managed for each group. Even when the server centralizes the management of the desktop environments of many client terminals, the desktop environments serving as management targets are grouped. The desktop environments are generally grouped in the order of models (broad category)→application programs (narrow category). For example, assume that there are (two types×two types) four desktop environments: (a) desktop environment 1 where application program A runs on model X, (b) desktop environment 2 where application program B runs on model X, (c) desktop environment 3 where application program A runs on model Y, and (d) desktop environment 4 where application program B runs on model Y. These desktop environments are first classified into model X and model Y, and then classified into application program A and application program B for respective models X and Y.

However, a user generally pays attention not to a model but to an application program he or she wants to use. Despite this, if desktop environments are created based on the aforementioned classification method, procedures of stacking, as the first layer, model-dependent elements such as a device driver and then, as the second layer, model-independent elements such as an OS and application program are adopted.

For example, when model-dependent elements such as a device driver and model-independent elements such as an application program are compared in terms of the update and module addition frequencies, the frequencies are much higher for the latter elements. In the above-described example, when application program B needs to be updated, update targets are desktop environment 2 and desktop environment 4. However, it is not always easy to specify desktop environment 2 and desktop environment 4 from application program B. Further, desktop environment 2 and desktop environment 4 have different first layers. Update work of desktop environment 2 and desktop environment 4 along with update of application program B inevitably becomes complicated. It is therefore necessary to efficiently manage the desktop environments (virtual image files) of client terminals.

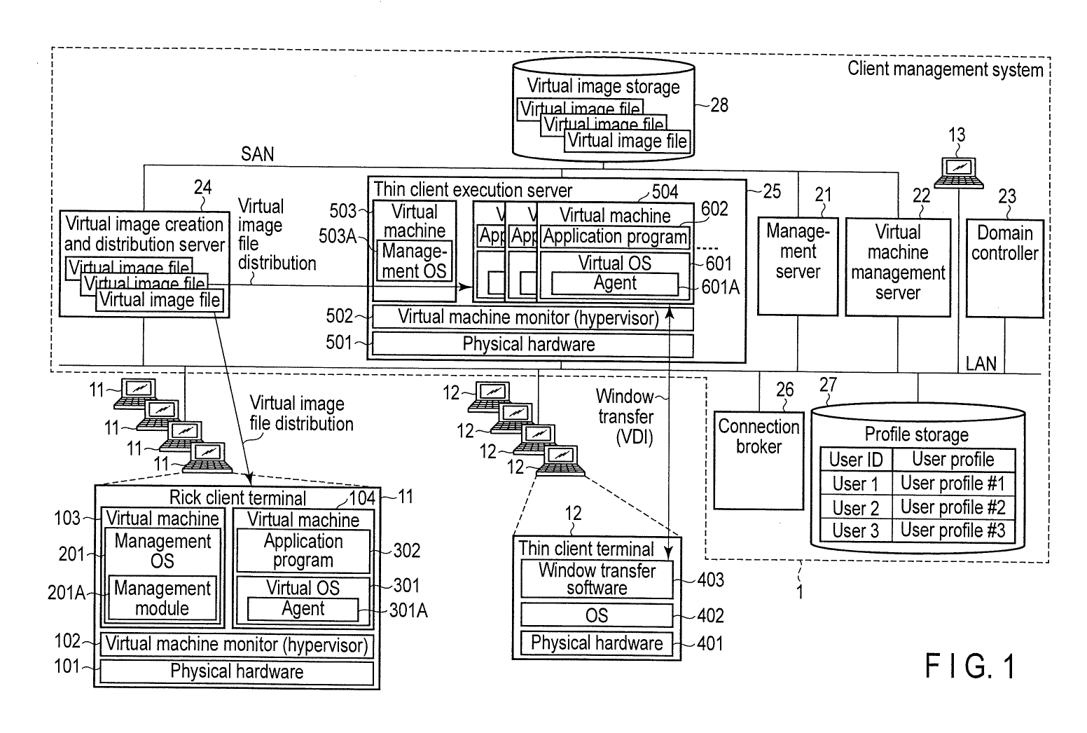

FIG. 1 shows the configuration of a client management system 1 to which an information processing apparatus (virtual image creation and distribution server 24) according to the embodiment is applied. The client management system 1 is a server system for managing a plurality of client terminals. The client management system 1 can be implemented by one or a plurality of servers (physical servers). Assume that the client management system 1 is implemented by a plurality of servers.

As shown in FIG. 1, the client management system 1 includes a management server 21, a virtual machine management server 22, a domain controller 23, the virtual image creation and distribution server 24, a thin client execution server 25, a connection broker 26, a profile storage 27, and a virtual image storage 28.

The management server 21, virtual machine management server 22, domain controller 23, virtual image creation and distribution server 24, thin client execution server 25, connection broker 26, and profile storage 27 are connected to a network such as a local area network (LAN). First type client terminals 11, second type client terminals 12, and a manager terminal 13 are also connected to this network.

The management server 21, virtual machine management server 22, virtual image creation and distribution server 24, and thin client execution server 25 are further connected to the virtual image storage 28 via another network such as a storage area network (SAN).

The client management system 1 is built in, for example, an office environment. The client management system 1 uses the management server 21 to centralize the management of a plurality of client terminals in an office. In the client management system 1, the profile storage 27 stores a plurality of user profiles applied to a plurality of client terminals. Each user profile contains setting information for setting the user environment of a client terminal to which the user profile is applied, for example, various kinds of setting information about each application program and various kinds of setting information about the desktop screen. Each user profile further contains user data such as a document file created by a user using an application program.

The client management system 1 in the embodiment can manage client terminals of two, first and second types. The client terminal 11 shown in FIG. 1 is the first type client terminal. The first type client terminal is a so-called virtualization client terminal. A virtual machine monitor (hypervisor) is installed as virtualization software in the local storage of the first type client terminal. The first type client terminal executes the virtualization software, and an OS and application program in a virtual image file distributed from the client management system 1.

More specifically, in the first type client terminal (to be referred to as a rich client terminal 11 hereinafter), a virtual machine monitor 102 is executed on physical hardware 101 including a CPU, memory, storage, and various I/O devices. The virtual machine monitor 102 is virtualization software such as a hypervisor, and functions as a virtualization layer on the physical hardware 101 by emulating the resource of the physical hardware 101. Several virtual machines are executed on the virtual machine monitor 102 serving as the virtualization layer. FIG. 1 assumes that two virtual machines 103 and 104 are executed on the virtual machine monitor 102. The virtual machine 103 is a virtual machine for executing a management OS (host OS) 201. The virtual machine 104 executes a virtual OS (guest OS) 301 and application program 302 in a virtual image file distributed from the client management system 1. The virtual machine 104, that is, the virtual OS (guest OS) 301 and application program 302 operate as the desktop environment of the rich client terminal 11.

The management OS (host OS) 201 can control the virtual machine 104 in cooperation with the virtual machine monitor 102. The management OS (host OS) 201 includes a management module 201A. The management module 201A can download a virtual image file from the virtual image creation and distribution server 24 of the client management system 1. The virtual OS (guest OS) 301 includes an agent 301A. The agent 301A is a program which executes processing to make the client management system 1 and the rich client terminal 11 cooperate with each other.

The second type client terminals are thin client terminals. By using a screen transfer protocol, the thin client terminals 12 communicate with respective virtual machines 504 which are executed on the thin client execution server 25 of the client management system 1. In other words, a plurality of thin client terminals 12 are terminals (base terminals) for implementing desktop virtualization using a virtual desktop infrastructure (VDI). The thin client execution server 25 serving as a virtualization server centralizes the management of the desktop environments (OSs and application programs) of the respective thin client terminals 12. One virtual machine 504 on the thin client execution server 25 is assigned to each thin client terminal 12. An OS and application program are executed not on the thin client terminal 12 but by the virtual machine 504 on the thin client execution server 25.

Each thin client terminal 12 transmits, to the corresponding virtual machine 504 in the thin client execution server 25, input information corresponding to an operation to an input device (for example, keyboard and mouse) by a user. Each thin client terminal 12 receives screen (window) information reflecting the input information from the corresponding virtual machine 504 in the thin client execution server 25.

More specifically, the thin client terminal 12 executes window transfer software 403. The window transfer software 403 is a program which communicates with the virtual machine 504 in the thin client execution server 25 using the screen transfer protocol. The window transfer software 403 may be an application program running on the OS. In this case, in the thin client terminal 12, an OS 402 is executed on physical hardware 401 including a CPU, memory, and various I/O devices, and the window transfer software 403 is executed on the OS 402.

Next, the respective components of the client management system 1 will be explained.

The management server 21 is a server for managing the operation of the client management system 1 according to the embodiment. The management server 21 can execute management of each user who can use the client management system 1, management of a virtual image file corresponding to each rich client terminal 11, and the like in accordance with an operation to the manager terminal 13 connected to a network such as a LAN. The virtual machine management server 22 is a server for managing the thin client execution server 25. The domain controller 23 is a server for authenticating each user and each client terminal.

The virtual image creation and distribution server 24 is an information processing apparatus according to the embodiment, and functions as a distribution server which distributes virtual image files each containing an OS and application program to a plurality of rich client terminals 11. The information processing apparatus according to the embodiment, that is, the virtual image creation and distribution server 24 includes a mechanism of creating virtual image files in order to efficiently manage the virtual image files. This will be described in detail below.

The virtual image creation and distribution server 24 can create not only a virtual image file for the rich client terminal 11, but also a virtual image file for the thin client terminal 12. A virtual image file for the rich client terminal 11 is distributed to each rich client terminal 11. A virtual image file for the thin client terminal 12 is distributed to the thin client execution server 25. Each virtual image file is, for example, a disk image file having the virtual hard disk (VHD) format.

The thin client execution server 25 is a server which executes a plurality of virtual machines for communicating with a plurality of thin client terminals 12 using the screen transfer protocol. The thin client execution server 25 may be implemented by, for example, one physical server virtualized by a server virtualization technique.

In the thin client execution server 25, a virtual machine monitor 502 is executed on physical hardware 501 including a CPU, memory, storage, and various I/O devices. The virtual machine monitor 502 is virtualization software such as a hypervisor, and functions as a virtualization layer on the physical hardware 501 by emulating the resource of the physical hardware 501. On the virtual machine monitor 502, one virtual machine 503 for management and a plurality of virtual machines 504 for executing a virtual desktop environment are executed. The virtual machine 503 executes a management OS (host OS) 503A. Each virtual machine 504 executes a virtual OS (guest OS) 601 and application program 602 in a virtual image file distributed from the virtual image creation and distribution server 24.

The management OS (host OS) 503A can control each virtual machine 504 in cooperation with the virtual machine monitor 502. The virtual OS (guest OS) 601 includes an agent 601A. Similar to the agent 301A in the virtual machine 104 of the rich client terminal 11, the agent 601A is a program which executes processing to make the client management system 1 and each thin client terminal 12 cooperate with each other.

The connection broker 26 is a server applied to the client management system 1 for management of user profiles and the like. The connection broker 26 can be implemented by one physical server.

The connection broker 26 manages a plurality of user profiles using the profile storage 27 which stores a plurality of user profiles corresponding to respective users. The connection broker 26 also includes a function of assigning an available virtual machine on the thin client execution server 25 to a user who has executed a logon operation on the thin client terminal 12. Further, the connection broker 26 includes a function (roaming function) of allowing each user to use the same user environment regardless of a client terminal on which he or she has performed a logon operation.

The profile storage 27 stores many user profiles associated with the identifiers (user IDs) of many users who can use the client management system 1. The profile storage 27 includes many storage locations for storing user profiles corresponding to many users. When a given user performs a logon operation to connect (log on) a given client terminal to the client management system 1, a user profile associated with the user ID of the user is automatically mounted on the file system of a virtual machine corresponding to the client terminal. For example, in logon processing of the rich client terminal 11, a user profile corresponding to a user who has performed the logon operation is mounted on the file system of the virtual machine 104 in the rich client terminal 11. The entity of the user profile (setting information and user data) does not exist in a local storage in the rich client terminal 11, and is managed in the client management system 1. This can enhance the security of the rich client terminal 11.

In logon processing of the thin client terminal 12, a user profile associated with the user ID of a user who has performed the logon operation is automatically mounted on the file system of a virtual machine 504 in the thin client execution server 25 that corresponds to the thin client terminal 12.

Accordingly, each user can use the same user environment (same user profile) regardless of which of the rich client terminal 11 and thin client terminal 12 has been operated by him or her to log on to the client management system 1.

The virtual image storage 28 is a storage for storing virtual image files created by the virtual image creation and distribution server 24.

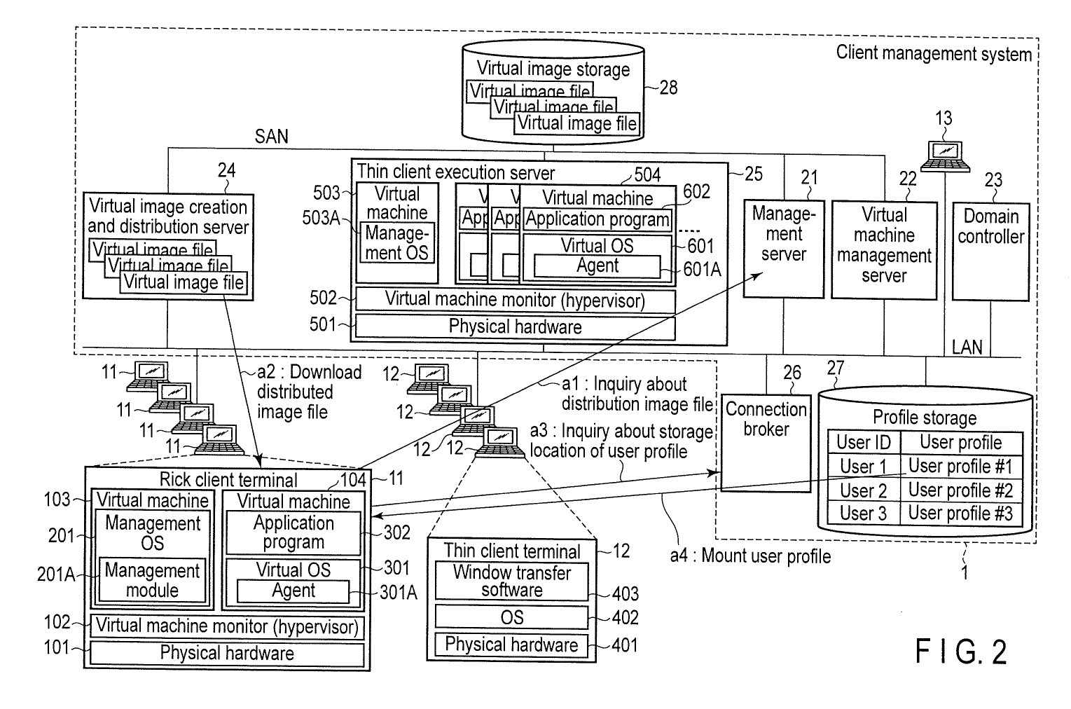

The operation sequence of the rich client terminal 11 will be explained with reference to FIG. 2.

(1) The management module 201A or agent 301A in the rich client terminal 11 inquires of the management server 21 whether there is a distribution image (virtual image file) to be applied to the rich client terminal 11. For example, when no virtual image file exists in the local storage of the rich client terminal 11, or when an updated virtual image file corresponding to a virtual image file which has already been distributed to the rich client terminal 11 exists in the client management system 1, the management server 21 notifies the management module 201A or agent 301A of the identifier of the virtual image file to be downloaded.

(2) The management module 201A or agent 301A requests the virtual image file having the notified identifier of the virtual image creation and distribution server 24, and downloads the virtual image file from the virtual image creation and distribution server 24. By activating or reactivating the virtual machine 104, the OS (virtual OS) 301 in the downloaded virtual image file starts.

(3) The virtual OS 301 displays a logon screen. The user performs a logon operation on the logon screen. The virtual OS 301 performs user authentication in cooperation with the domain controller 23. If the user authentication has succeeded, the virtual machine 104 (agent 301A) transmits a connection request to the connection broker 26 and inquires, of the connection broker 26, the storage location of a user profile corresponding to the user who has performed the logon operation. The connection request is a request to connect (log on) the rich client terminal 11 to the client management system 1, and contains the user account (user ID) of the user who has performed the logon operation. The user ID is an identifier for uniquely identifying the user. The connection broker 26 transmits, to the virtual machine 104 (agent 301A), information, i.e., storage path representing a path to a storage location in the profile storage 27 where a user profile associated with the user ID of the user is stored.

(4) The virtual machine 104 (agent 301A) mounts, on the file system of the virtual machine 104 (virtual OS 301), the storage location of the user profile in the profile storage 27. To read or write the user profile, the virtual machine 104 accesses not the local storage of the rich client terminal 11 but the storage location of the user profile in the profile storage 27.

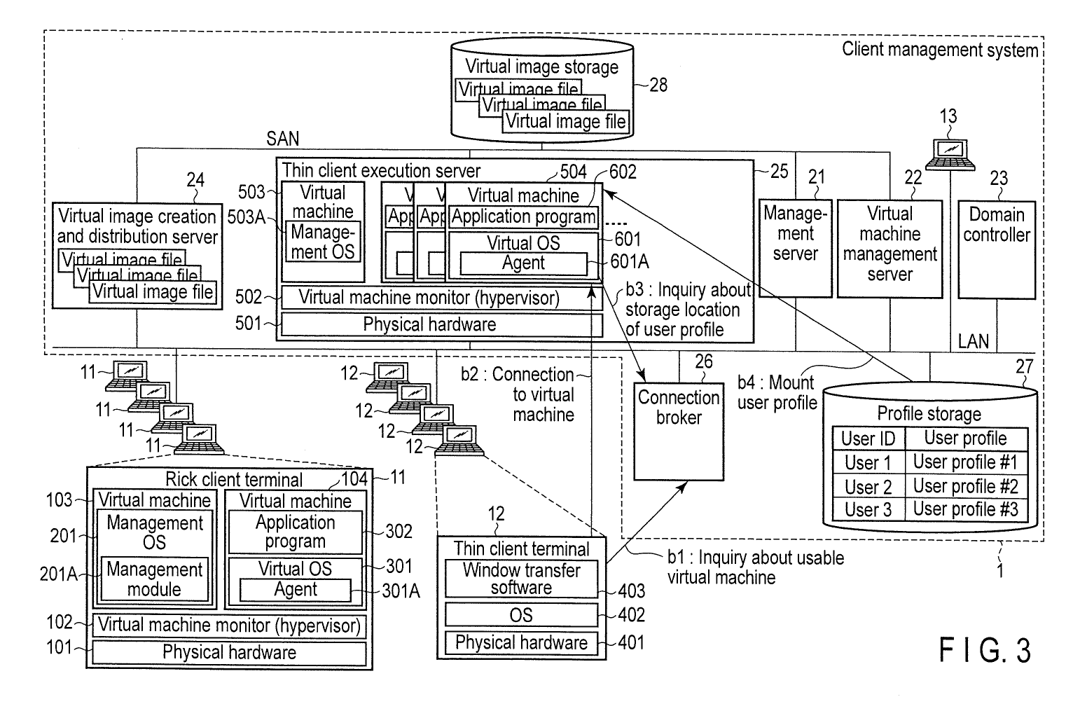

The operation sequence of the thin client terminal 12 will be explained with reference to FIG. 3.

(1) The OS 402 or window transfer software 403 of the thin client terminal 12 inquires an available virtual machine of the connection broker 26. The connection broker 26 transmits, to the thin client terminal 12, information which designates a virtual machine 504 on the thin client execution server 25 that can be used by the thin client terminal 12. In this case, the connection broker 26 may transmit, to the thin client terminal 12, a list of virtual machines 504 on the thin client execution server 25 that can be used by the thin client terminal 12. For example, the connection broker 26 can transmit, to the thin client terminal 12, a screen for displaying, based on a user ID contained in the inquiry, a list of virtual machines 504 which can execute a desktop environment corresponding to the user and are not currently used. The user selects one virtual machine 504 from the displayed list of the virtual machines 504.

(2) The OS 402 or window transfer software 403 connects the virtual machine 504 designated by the connection broker 26 or the virtual machine 504 selected from the list of the virtual machines 504, and activates the connected virtual machine 504. In response to this, the virtual OS 601 in the virtual machine 504 starts.

(3) The virtual OS 601 displays a local screen. The user performs a logon operation on the logon screen. The virtual OS 601 performs user authentication in cooperation with the domain controller 23. If the user authentication has succeeded, the virtual machine 504 (agent 601A) transmits a connection request to the connection broker 26 and inquires, of the connection broker 26, the storage location of a user profile corresponding to the user who has performed the logon operation. The connection request is a request to connect (log on) the thin client terminal 12 to the client management system 1, and contains the user account (user ID) of the user who has performed the logon operation. The connection broker 26 notifies the virtual machine 504 (agent 601A) of information, i.e., storage path representing a path to a storage location in the profile storage 27 where a user profile associated with the user ID of the user is stored.

(4) The virtual machine 504 (agent 601A) automatically mounts, on the file system of the virtual machine 504 (virtual OS 601), the storage location of the user profile in the profile storage 27. To read or write the user profile, the virtual machine 504 accesses not the local storage of the thin client execution server 25 but the storage location of the user profile in the profile storage 27.

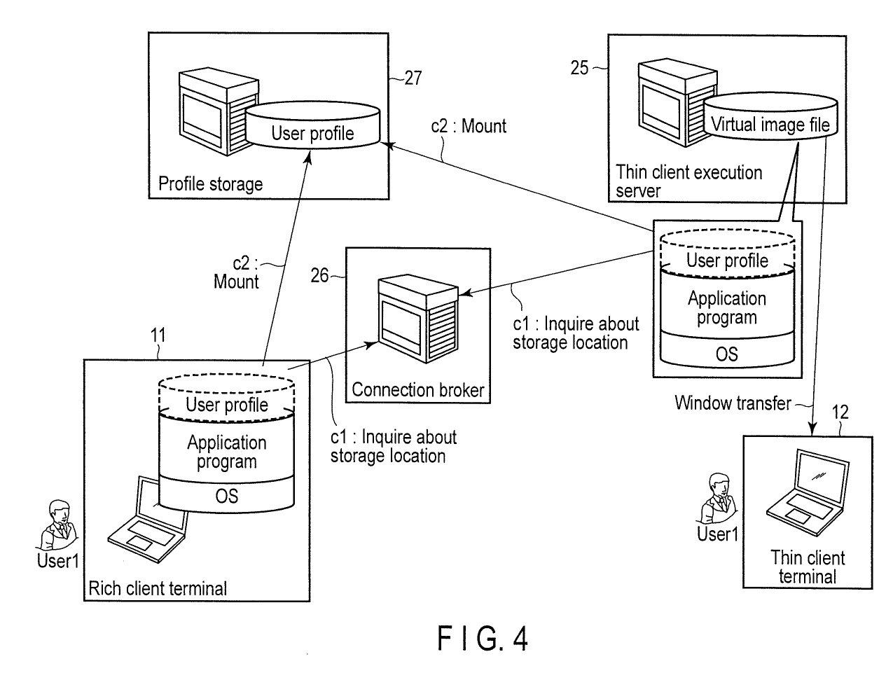

The roaming function to be executed by the connection broker 26 will be explained with reference to FIG. 4.

The roaming function is a function of allowing each user to use the same user profile corresponding to him or her regardless of which of the rich client terminal 11 and thin client terminal 12 has been used by the user.

Assume that the rich client terminal 11 is placed on the desk of each user, and the thin client terminal 12 is placed in a meeting room or public space. Each user can log on to the client management system 1 by operating the rich client terminal 11 on his or her desk. When the user moves to the meeting room or public space, he or she can log on to the client management system 1 by operating the thin client terminal 12. In this case, regardless of client terminals used by the user, the roaming function provides the same user profile to virtual machines corresponding to the client terminals.

First, processing to be executed by the connection broker 26 when the user has performed a logon operation on the rich client terminal 11 will be described.

(1) A user (User 1) performs a logon operation to connect the rich client terminal 11 on his or her desk to the client management system 1. The virtual machine 104, for example, agent 301A of the rich client terminal 11 transmits a connection request to the connection broker 26 and inquires, of the connection broker 26, the storage location of a user profile corresponding to the user (User 1) who has performed the logon operation.

(2) The connection broker 26 transmits the storage path of the user profile of the user (User 1) to the virtual machine 104 of the rich client terminal 11. The virtual machine 104 mounts the user profile of the user (User 1) on the file system of the virtual machine 104. The file system of the virtual machine 104 is a file system managed by the virtual OS 301 in the virtual machine 104.

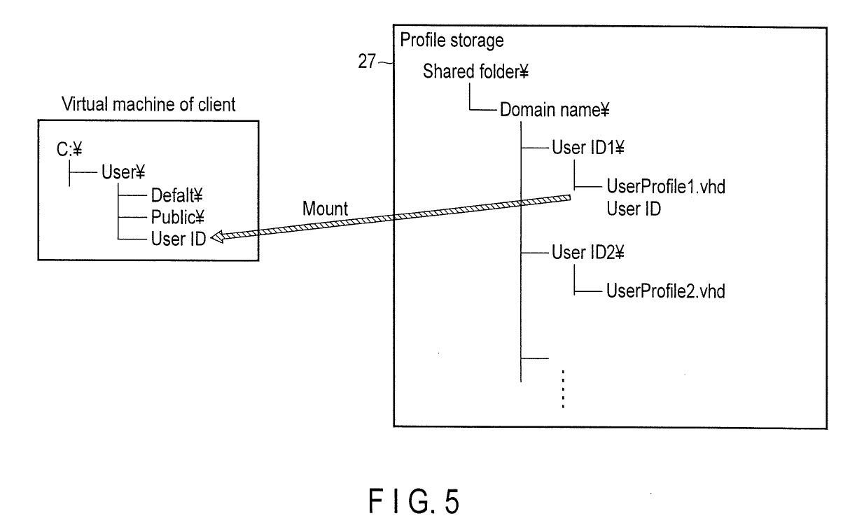

Each user profile in the profile storage 27 may be a virtual image file having the virtual hard disk (VHD) format. In this case, the virtual image file of the user profile is mounted at a predetermined mount point on the file system of the virtual machine 104. For example, a predetermined directory (user profile directory) in the file system that is used to store a user profile is used as the mount point. FIG. 5 shows this state. As shown in FIG. 5, folders (user ID1¥, user ID2¥, . . . ) corresponding to a plurality of user IDs (user ID1, user ID2, . . . ) exist in the profile storage 27. These folders (user ID1¥, user ID2¥, . . . ) store user profiles (UserProfile1.vhd, UserProfile2.vhd, . . . ) associated with the respective user IDs (user ID1, user ID2, . . . ). UserProfile1.vhd is mounted in a user profile directory (user ID1) on the file system of the virtual machine 104.

The virtual OS 301 can read the user profile mounted on the file system from the profile storage 27, and perform setting of an application program, setting of a desktop environment, and the like based on setting information in the user profile. User data such as various documents also exists in the user profile. The virtual OS 301 can read user data in the user profile mounted on the file system from the profile storage 27, and display the user data on the display of the rich client terminal 11. Updated user data, setting information, and the like are stored not in the local storage of the rich client terminal 11 but in the profile storage 27.

Next, processing to be executed by the connection broker 26 when the user has performed a logon operation on the thin client terminal 12 will be described.

(1) The user (User 1) performs a logon operation to connect the thin client terminal 12 installed in, for example, a public space to the client management system 1. A virtual machine 504, for example, agent 601A on the thin client execution server 25 that corresponds to the thin client terminal 12 transmits a connection request to the connection broker 26 and inquires, of the connection broker 26, the storage location of a user profile corresponding to the user (User 1) who has performed the logon operation.

(2) The connection broker 26 transmits the storage path of the user profile of the user (User 1) to the virtual machine 504 on the thin client execution server 25 that corresponds to the thin client terminal 12. The virtual machine 504 mounts the user profile of the user (User 1) on the file system of the virtual machine 504. The file system of the virtual machine 504 is a file system managed by the virtual OS 601 in the virtual machine 504. The virtual OS 601 can read the user profile mounted on the file system from the profile storage 27, and perform setting of an application program, setting of a desktop environment, and the like based on setting information in the user profile.

In this manner, each user can use the same user environment regardless of a client terminal on which he or she has performed a logon operation.

In some cases, a program (update patch) for, for example, correcting a bug is irregularly provided to the application program 302 in a virtual image file executed on the virtual machine 104 of the rich client terminal 11 or the application program 602 in a virtual image file executed on the virtual machine 504 of the thin client execution server 25. There may be a request to add the application program 302 or 602 for use in the rich client terminal 11 or thin client terminal 12. Such update and module addition require update of a virtual image file. To efficiently manage virtual image files (by unique procedures), the virtual image creation and distribution server 24 executes virtual image file creation processing.

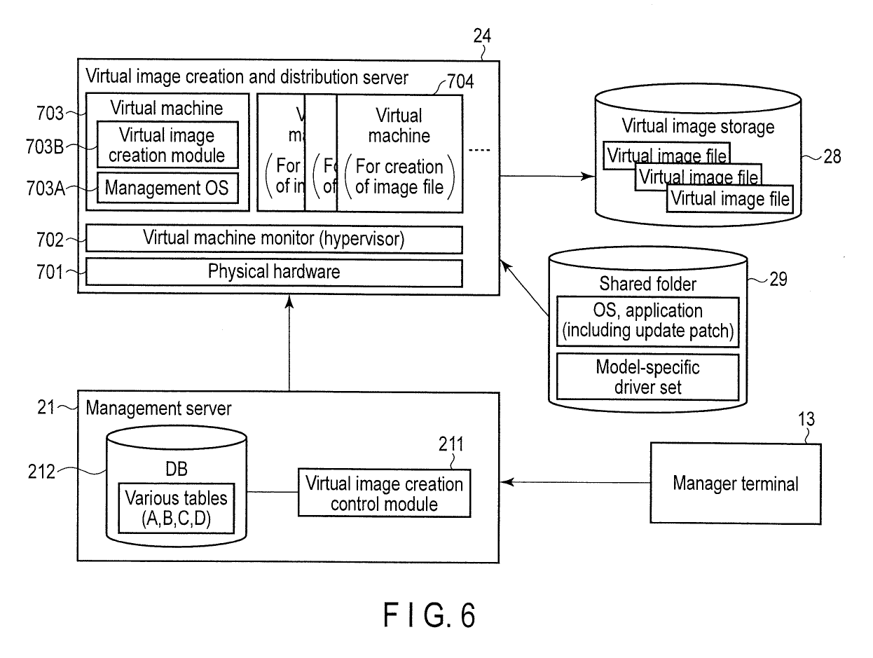

FIG. 6 is an exemplary block diagram for explaining cooperation to create a virtual image file in the client management system 1.

When creating a virtual image file for the rich client terminal 11 or thin client terminal 12, the management server 21 accepts, from the manager terminal 13, an instruction representing a virtual image file to be created. The management server 21 notifies the virtual image creation and distribution server 24 of the requested virtual image file creation instruction. The management server 21 includes a virtual image creation control module 211 which controls virtual image file creation processing. The management server 21 manages a database 212 for storing various tables (A, B, C, and D) (to be described later).

As shown in FIG. 6, in the virtual image creation and distribution server 24, a virtual machine monitor 702 is executed on physical hardware 701 including a CPU, memory, storage, and various I/O devices. The virtual machine monitor 702 is virtualization software such as a hypervisor, and functions as a virtualization layer on the physical hardware 701 by emulating the resource of the physical hardware 701. On the virtual machine monitor 702, one virtual machine 703 for management and a plurality of virtual machines 704 for creating a virtual image file are executed. The virtual machine 703 executes a management OS (host OS) 703A and virtual image file creation module 703B. Each virtual machine 704 is used for creating, by the virtual image file creation module 703B, a virtual image file designated by the management server 21. More specifically, the virtual machine 704 is used as a work environment for creating the image file (disk image file) of a disk in which an OS, application program, and model-specific device driver set, which are stored in a shared folder 29 set in a file server (not shown) in the client management system 1, are installed.

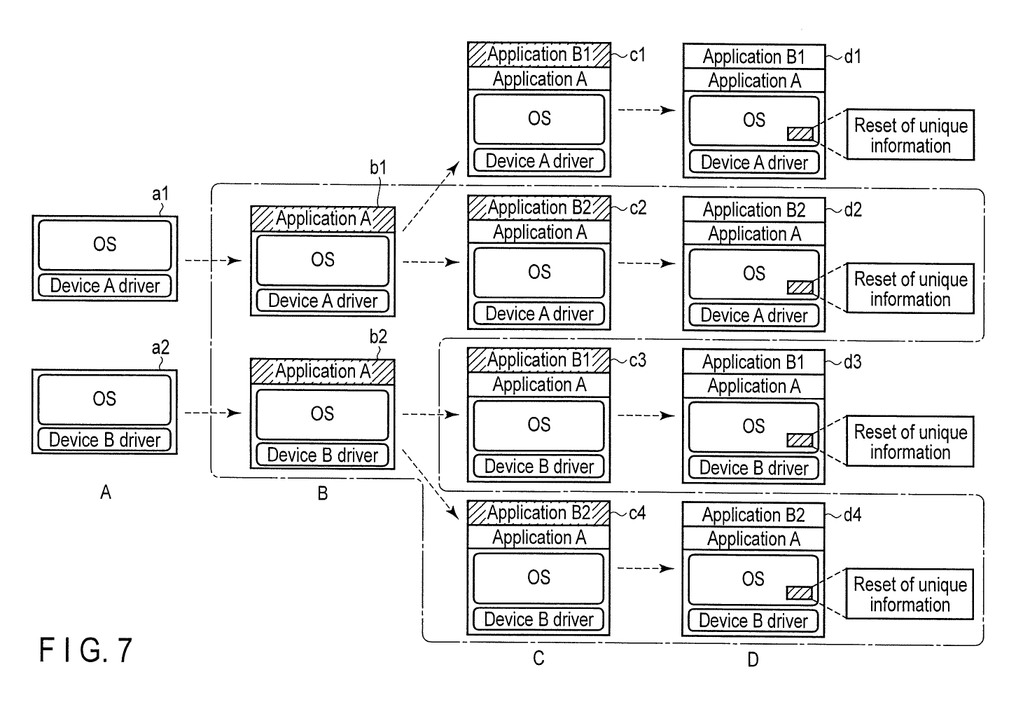

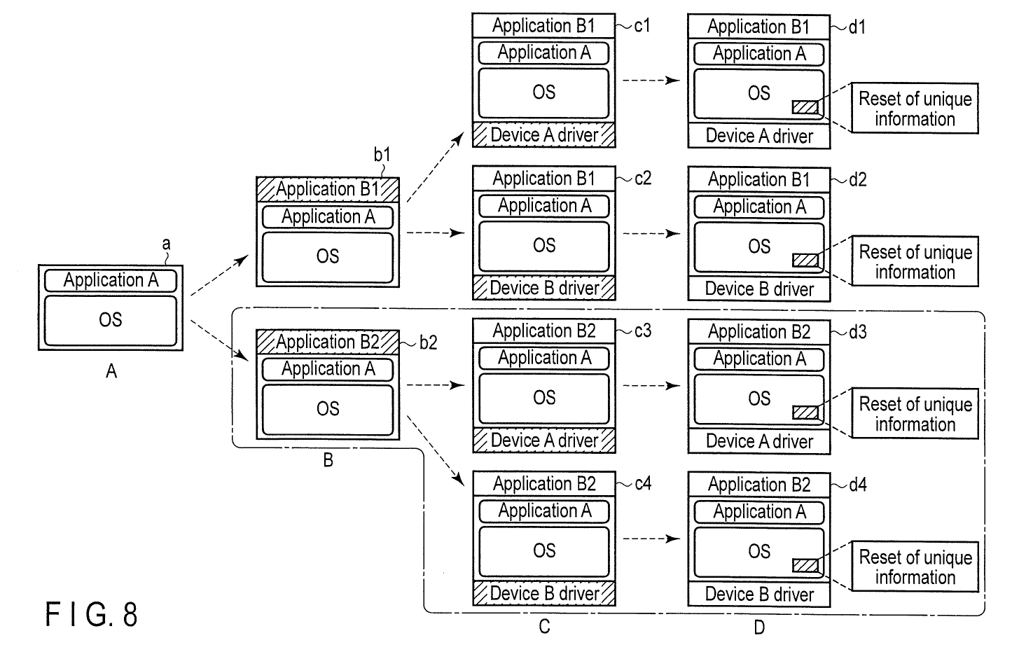

To help understand virtual image file creation processing to be executed in the client management system 1 according to the embodiment, processes of building a virtual image file will be explained with reference to FIG. 7 and FIG. 8.

FIG. 7 is an exemplary view for explaining conventional processes of building a virtual image file. Assume that application program A is a program commonly used throughout a company. Also, assume that two types of devices A and B (regardless of the department) are used, application program B1 is used in a given department, and application program B2 is further used in another department.

In this case, first, virtual image file a1 serving as the image file of a disk in which an OS and a device driver for device A are installed, and virtual image file a2 serving as the image file of a disk in which an OS and a device driver for device B are installed are created (“A” in FIG. 7). Second, virtual image file b1 serving as the image file of a state in which application program A commonly used throughout the company is installed in the disk imaged as virtual image file a1, and virtual image file b2 serving as the image file of a state in which application program A commonly used throughout the company is installed in the disk imaged as virtual image file a2 are created (“B” in FIG. 7). Note that the entities of virtual image files b1 and b2 are obtained by adding difference files to virtual image files a1 and a2, respectively. That is, creation of virtual image files b1 and b2 is creation of difference files for building virtual image files b1 and b2 based on virtual image files a1 and a2.

Third, after creating virtual image files b1 and b2, virtual image files c1 to c4 in each of which either application program B1 or B2 is further installed for either virtual image file b1 or b2 are created (“C” of FIG. 7). Finally, virtual image files d1 to d4 in which unique information temporarily input in installation are reset in respective virtual image files c1 to c4 are created (“D” in FIG. 7). By adding unique information to virtual image files d1 to d4, virtual image files serving as final products to be distributed to the rich client terminal 11 or thin client execution server 25 can be created. Creation of virtual image files c1 to c4 and d1 to d4 is also creation of difference files from virtual image files b1 and b2 or c1 to c4.

In this fashion, the conventional processes include processes of building virtual image files in the order of model-dependent elements such as a device driver (broad category)→model-independent elements such as an application program (narrow category).

For example, assume that application program B2 needs to be updated. In this case, virtual image files created by adding unique information to virtual image files d2 and d4 need to be updated. However, it is cumbersome to specify a virtual image file containing a given application program for each device. This work becomes more cumbersome as the number of types of devices increases. In addition, two work operations need to be executed to create virtual image file c2→virtual image file d2 using virtual image file b1 as an origin, and create virtual image file c4→virtual image file d4 using virtual image file b2 as an origin. The number of work operations increases as the number of types of devices increases.

FIG. 8 is an exemplary view for explaining processes of building a virtual image file in the client management system 1 according to the embodiment.

In the client management system 1 according to the embodiment, first, virtual image file a serving as the image file of a disk in which an OS and application program A commonly used throughout the company are installed is created (“A” in FIG. 8). Then, virtual image files b1 and b2 in each of which either application program B1 or B2 is further installed in virtual image file a are created (“B” in FIG. 8). After that, virtual image files c1 to c4 in each of which either a device driver for device A or a device driver for device B is further installed in either virtual image file b1 or b2 are created (“C” of FIG. 8). Virtual image files d1 to d4 in which unique information temporarily input in installation are reset are created (“D” in FIG. 8).

That is, the client management system 1 according to the embodiment employs processes of building virtual image files in the order of model-independent elements such as an application program (broad category)→model-dependent elements such as a device driver (narrow category).

In the case where virtual image files are created according to these procedures, if application program B2 needs to be updated, virtual image files d3 and d4 created using virtual image file b2 as an origin can be easily specified. It suffices to perform only one work operation of creating virtual image files c3 and c4→virtual image files d3 and d4 using virtual image file b2 as an origin. This can implement efficient management of the desktop environments (virtual image files) of client terminals.

When a device-dependent element such as a device driver needs to be updated, virtual image file update processing can be performed efficiently by creating a virtual image file according to the conventional procedures. However, when device-dependent elements such as a device driver and device-independent elements such as an application program are compared, the update and module addition frequencies are much higher for the latter elements. With all things considered, virtual image files can be managed efficiently.

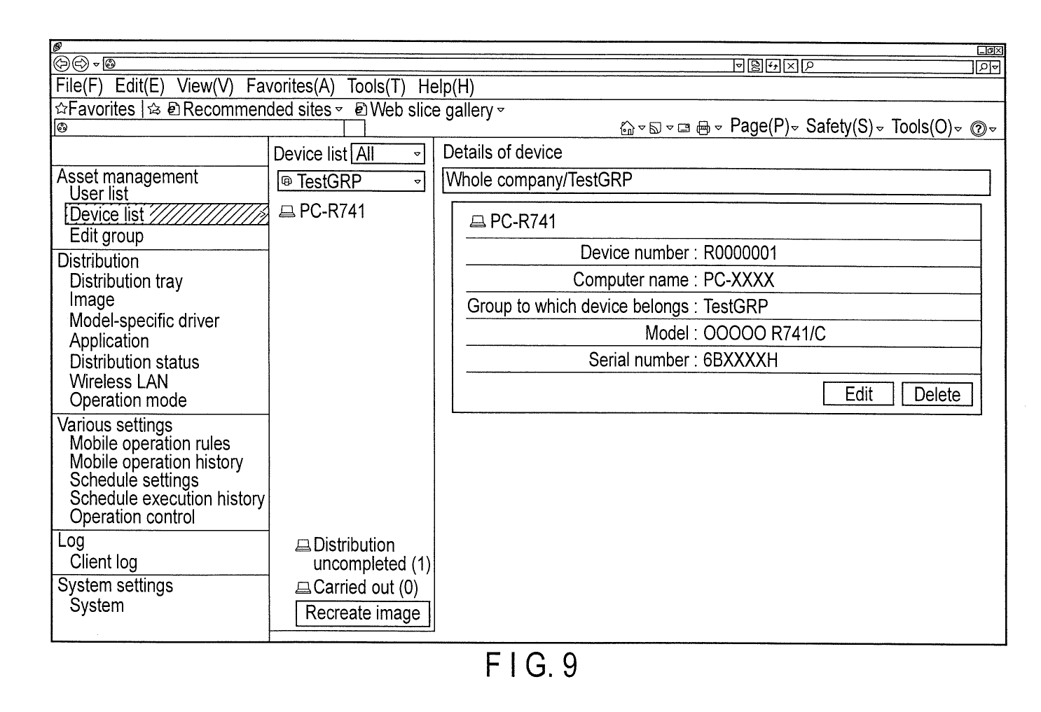

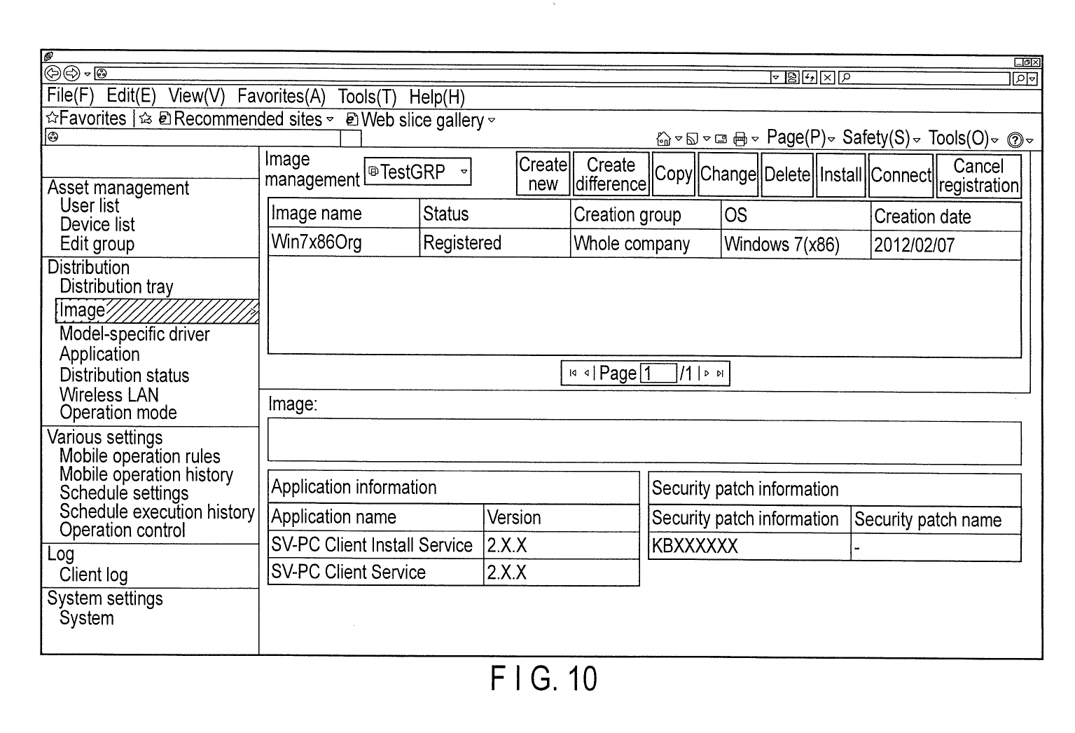

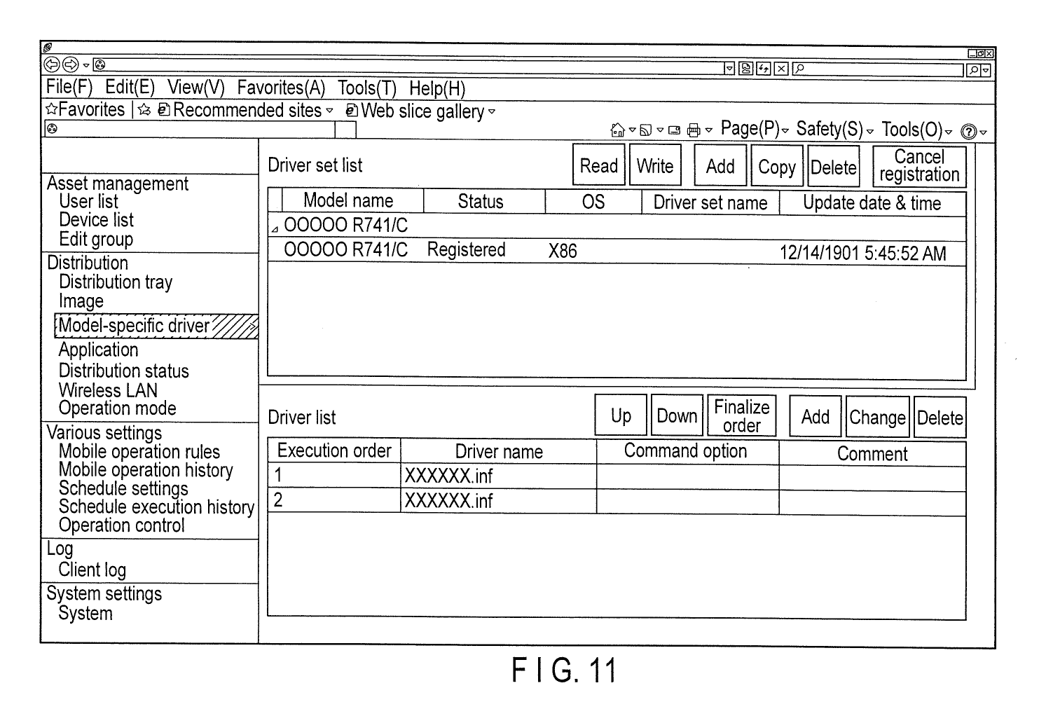

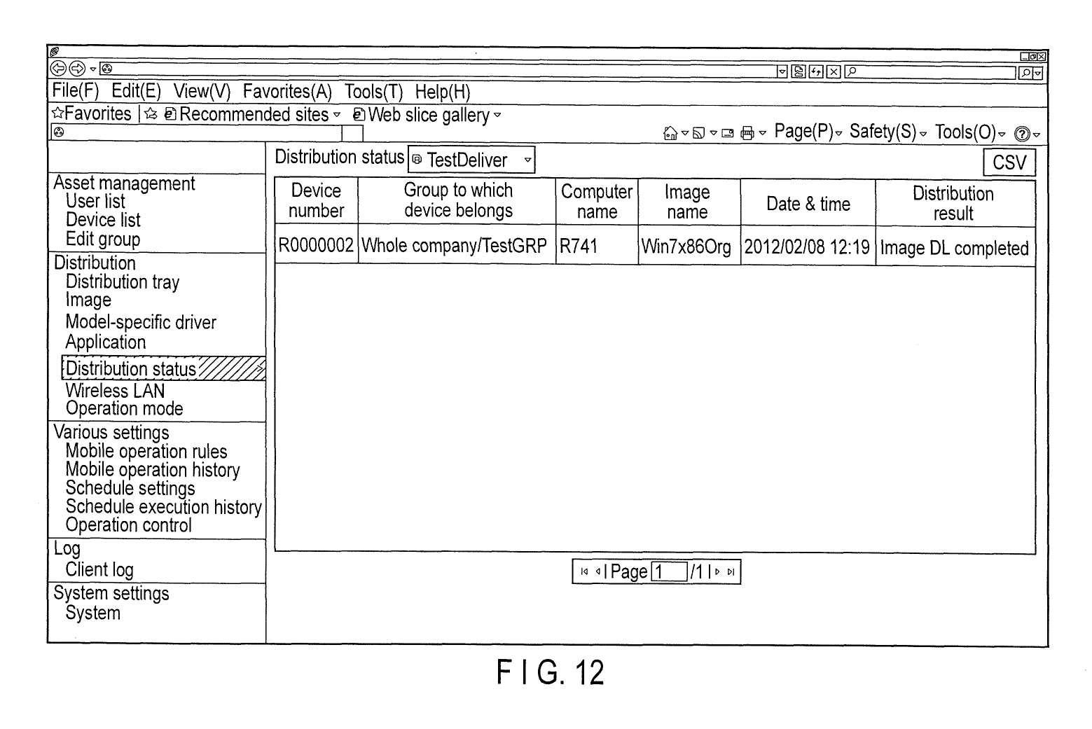

Various tables (A, B, C, and D) stored in the database 212 by the management server 21 will be explained with reference to FIG. 9, FIG. 10, FIG. 11 and FIG. 12.

FIG. 9 is an exemplary view exemplifying the display screen of table A to be looked up by the manager terminal 13. Table A is a table which stores device information, and holds “device number (key)”, “computer name”, “group to which device belongs”, “model”, and “serial number”, as shown in FIG. 9.

FIG. 10 is an exemplary view exemplifying the display screen of table B to be looked up by the manager terminal 13. Table B is a table which stores master image information, and holds image information (“image name” [key]), “status”, “creation group (parent group)”, “OS”, “creation date”, “application information (application name and version)”, and “security patch information” which serve as the base of a virtual image file to be created in the group to which the device belongs, as shown in FIG. 10.

FIG. 11 is an exemplary view exemplifying the display screen of table C to be looked up by the manager terminal 13. Table C is a table which stores a list of device-specific driver sets, and holds “model name (key)” and “driver list (driver name and execution order)”, as shown in FIG. 11.

FIG. 12 is an exemplary view exemplifying the display screen of table D to be looked up by the manager terminal 13. Table D is a table which manages a distribution image, and holds “device number (key)”, “group to which device belongs”, “computer name”, “image name”, “(distribution) date & time”, and “distribution result (status)”, as shown in FIG. 12.

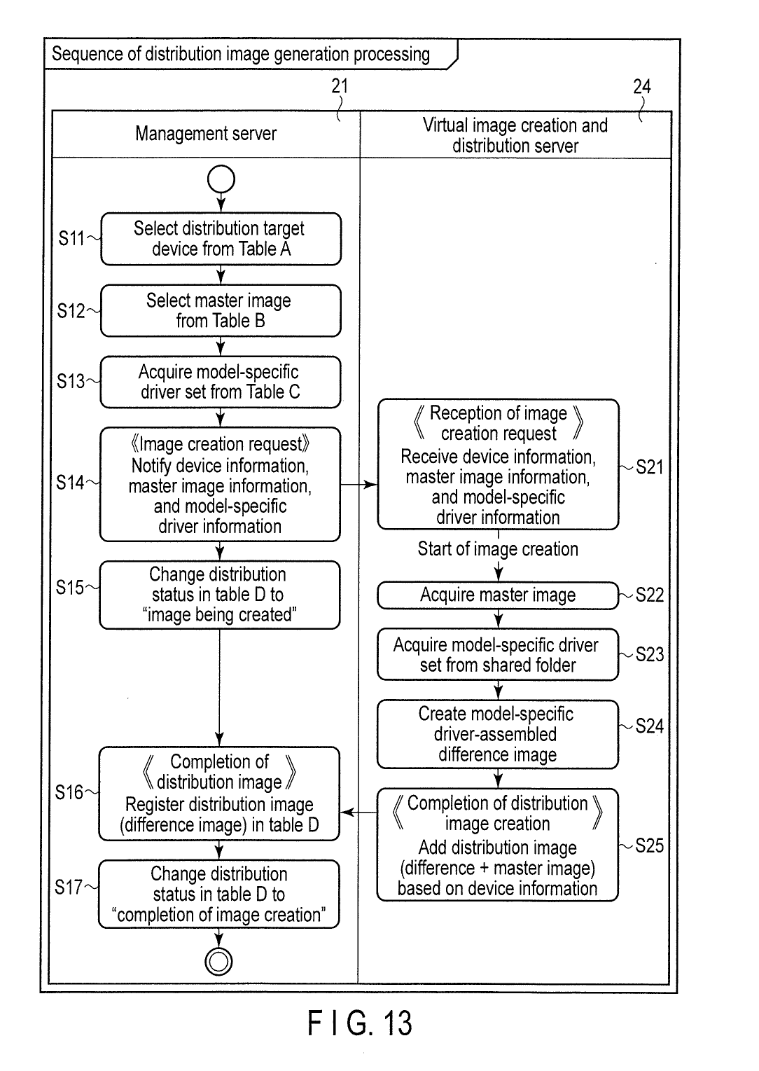

FIG. 13 is an exemplary flowchart showing the sequence of virtual image file creation processing to be executed in the client management system 1 according to the embodiment (using the above tables [A, B, C, and D]).

In accordance with an operation to the manager terminal 13, the management server 21 selects, from table A, a device for which a distribution image is to be created (step S11). In accordance with an operation to the manager terminal 13, the management server 21 selects a master image containing an application program from table B (step S12). Then, in accordance with an operation of the manager terminal 13, the management server 21 selects, from table C, a model-specific driver set corresponding to the device selected from table A in step S11 (step S13).

Upon completion of these selections, in accordance with an operation to the manager terminal 13, the management server 21 notifies the virtual image creation and distribution server 24 of a request to start creation of a distribution image containing device information and master image information (step S14). At this time, the management server 21 changes “distribution status” in table D to “image being created” (step S15).

The virtual image creation and distribution server 24 receives this notification (step S21), acquires the master image (step S22), and then acquires a model-specific driver set from the shared folder (step S23). The virtual image creation and distribution server 24 creates a difference image by assembling the model-specific driver set in the master image (step S24). After creating the difference image, the virtual image creation and distribution server 24 notifies the management server 21 of a message to this effect (step S25).

Upon receiving the notification of completion of difference image creation from the virtual image creation and distribution server 24, the management server 21 registers the difference image name in “image name” of table D (step S16), and changes “distribution status” to “completion of image creation” (step S17).

Although a device driver is generally installed once in each model, the user sometimes wants to add, update, or delete an application program. Hence, model-independent elements such as an application program are grouped and managed. Only when a new model is added, a corresponding device driver is installed. This can shorten the time taken to add, update, or delete an application program, which occupies most of tasks of the manager.

Thus, the client management system 1 according to the embodiment can efficiently manage the desktop environments (virtual image files) of client terminals.

Operation control processing in the embodiment can be implemented by software (program). The software is installed in a general-purpose computer via a computer-readable storage medium which stores the software, and then is executed. As a result, the same effects as those in the embodiment can be easily implemented.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus applied to a client management system which manages desktop environments of a plurality of client terminals, the apparatus comprising:
a first image file creation module configured to create a first image file for each group classified by model-independent elements of the plurality of client terminals, the first image file being a disk image file for the desktop environments, the first image file not containing model-dependent elements of the plurality of client terminals; and
a second image file creation module configured to create a difference file for building a second image file containing the model-dependent elements of the plurality of client terminals based on the first image file.

2. The apparatus of claim 1, wherein the model-independent elements of the plurality of client terminals comprise an operating system.

3. The apparatus of claim 2, wherein the model-independent elements of the plurality of client terminals comprise an application program.

4. The apparatus of claim 1, wherein the model-dependent elements of the plurality of client terminals comprise a device driver.

5. An image file creation method for an information processing apparatus applied to a client management system which manages desktop environments of a plurality of client terminals, the method comprising:
creating a first image file for each group classified by model-independent elements of the plurality of client terminals, the first image file being a disk image file for the desktop environments, the first image file not containing model-dependent elements of the plurality of client terminals; and
creating a difference file for building a second image file containing the model-dependent elements of the plurality of client terminals based on the first image file.

6. The method of claim 5, wherein the model-independent elements of the plurality of client terminals comprise an operating system.

7. The method of claim 6, wherein the model-independent elements of the plurality of client terminals comprise an application program.

8. The method of claim 5, wherein the model-dependent elements of the plurality of client terminals comprise a device driver.

9. A computer-readable, non transitory storage medium having stored thereon a computer program which is executable by a computer applied to a client management system which manages desktop environments of a plurality of client terminals, the computer program controlling the computer to function as:
a first image file creation module configured to create a first image file for each group classified by model-independent elements of the plurality of client terminals, the first image file being a disk image file for the desktop environments, the first image file not containing model-dependent elements of the plurality of client terminals; and
a second image file creation module configured to create a difference file for building a second image file containing the model-dependent elements of the plurality of client terminals based on the first image file.

10. The medium of claim 9, wherein the model-independent elements of the plurality of client terminals comprise an operating system.

11. The medium of claim 10, wherein the model-independent elements of the plurality of client terminals comprise an application program.

12. The medium of claim 9, wherein the model-dependent elements of the plurality of client terminals comprise a device driver.
